(19) United States
(12) Patent Application Publication
(10) Pub. No.: US 2026/0313174 A1
(43) Pub. Date: Oct. 8, 2026

(54) PACKET LAKE: NOVEL NETWORK PRIMITIVE FOR LOW LATENCY VOLUMETRIC STREAMING

(71) Applicant: Nokia Solutions and Networks Oy, Espoo (FI)

(72) Inventors: Eugene CHAI, Murray Hill, NJ (US); Kittipat APICHARTTRISORN, Murray Hill, NJ (US); Hyunseok CHANG, Holmdel, NJ (US); Sarit MUKHERJEE, Murray Hill, NJ (US); Limin WANG, Plainsboro, NJ (US)

(73) Assignee: Nokia Solutions and Networks Oy, Espoo (FI)

(21) Appl. No.: 19/170,590

(22) Filed: Apr. 4, 2025

(51) Int. Cl. H04N 21/234; H04N 21/258; H04N 21/262; H04N 21/81

(52) U.S. Cl. CPC H04N 21/23406; H04N 21/25808; H04N 21/26258; H04N 21/816

(57) ABSTRACT

An apparatus includes at least one memory storing computer program code and at least one processor configured to execute the computer program code and cause the apparatus to receive a plurality of volumetric video packets of a volumetric video, store the plurality of volumetric video packets in a two-dimensional packet buffer, the two-dimensional packet buffer including a plurality of priority sub-queues, discard a stored volumetric data packet from a randomly selected priority sub-queue, of the plurality of priority sub-queues, in response to receiving a further volumetric video packet and the two-dimensional packet buffer being full, and transmit a volumetric video packet from the two-dimensional packet buffer to a client device.

### BACKGROUND

Real-time volumetric video events are transforming immersive Extended Reality (XR) experiences by enabling audiences to experience events from any perspective, as if physically present. Unlike traditional broadcasts, viewers can choose their viewpoints and zoom in, creating a personalized and interactive experience. However, latency, particularly meeting the critical 20 ms Motion-to-Photon (MtP) response time, remains a challenge. This response time ensures seamless user interactions and prevents motion sickness. The latency issue is exacerbated by the contrasting characteristics of core and edge networks. Core networks offer high bandwidth but have high latency, whereas edge networks offer lower latency but have limited bandwidth, complicating real-time data delivery.

### SUMMARY

The scope of protection sought for various example embodiments of the disclosure is set out by the independent claims. The example embodiments and/or features, if any, described in this specification that do not fall under the scope of the independent claims are to be interpreted as examples useful for understanding various embodiments.

One or more example embodiments disclose a novel programmable packet queuing and scheduling mechanism, referred to herein as Packet Lakes, designed to address latency challenges in delivering volumetric video for XR experiences. Packet Lakes include two-dimensional buffers with subqueues that prioritize packets based on spatial properties, allowing real-time adaptation to user context. Deployed at the network edge, Packet Lakes enable receiver-directed scheduling, priority-aware caching, and two-phase congestion control, reducing latency by pre-caching data and adjusting delivery based on XR client needs. This architecture enhances the XR experience by aligning network behavior with the user-centric demands of next-generation immersive applications.

At least one example embodiment provides an apparatus including at least one memory storing computer program code and at least one processor configured to execute the computer program code and cause the apparatus to receive a plurality of volumetric video packets of a volumetric video, store the plurality of volumetric video packets in a two-dimensional packet buffer, the two-dimensional packet buffer including a plurality of priority sub-queues, discard a stored volumetric data packet from a randomly selected priority sub-queue, of the plurality of priority sub-queues, in response to receiving a further volumetric video packet and the two-dimensional packet buffer being full, and transmit a volumetric video packet from the two-dimensional packet buffer to a client device.

According to at least one example embodiment, each priority sub-queue of the plurality of priority sub-queues may correspond with a respective segment of the volumetric video.

According to at least one example embodiment, the at least one memory and the computer program code may be further configured to, with the at least one processor, cause the apparatus to transmit the volumetric video packet from the two-dimensional packet buffer to the client device based on a sub-queue priority received from the client device.

According to at least one example embodiment, the sub-queue priority may be based on a field of vision of a user.

According to at least one example embodiment, the at least one memory and the computer program code may be further configured to, with the at least one processor, cause the apparatus to discard the stored volumetric video packet based on a circular sampling buffer.

According to at least one example embodiment, the at least one memory and the computer program code may be further configured to, with the at least one processor, cause the apparatus to store a received volumetric video packet in a priority sub-queue, of the plurality of priority sub-queues, corresponding with a sub-queue priority of the volumetric video packet, and add an entry to the circular sampling buffer corresponding with the received volumetric video packet.

According to at least one example embodiment, the priority sub-queue may be a priority linked list, and the at least one memory and the computer program code may be further configured to cause the apparatus to store the received volumetric video packet in the priority linked list according to a scene priority level of the volumetric video packet.

According to at least one example embodiment, the at least one memory and the computer program code may be further configured to, with the at least one processor, cause the apparatus to, in response to receiving the further volumetric video packet and the two-dimensional packet buffer being full, randomly select an entry from a circular sampling buffer, discard a lowest priority volumetric video packet from a priority sub-queue of the plurality of priority sub-queues corresponding with a sub-queue priority of the selected entry, and discard an entry from the circular sampling buffer corresponding with the discarded volumetric video packet.

At least one example embodiment provides a client device including at least one memory storing computer program code, and at least one processor configured to execute the computer program code to cause the client device to determine a sub-queue priority based on a field of view of a user, transmit the sub-queue priority to an apparatus having a two-dimensional packet buffer including a plurality of priority sub-queues, each of the plurality of priority sub-queues including a plurality of volumetric video packets of a volumetric video, receive, from the apparatus, volumetric video packets from one or more of the plurality of priority sub-queues based on the sub-queue priority, and display a volumetric video based on the volumetric video packets.

According to at least one example embodiment, the at least one memory and the computer program code may be further configured to, with the at least one processor, cause the client device to determine the sub-queue priority based on a mapping between spatial segments of the volumetric video and the plurality of priority sub-queues.

According to at least one example embodiment, the at least one memory and the computer program code may be further configured to, with the at least one processor, cause the client device to transmit a client state of the user to a server, and receive, from the server, an updated mapping between spatial segments of the volumetric video and the plurality of priority sub-queues based on the client state.

At least one example embodiment provides a method for transmitting volumetric video, the method including receiving a plurality of volumetric video packets of the volumetric video, storing the plurality of volumetric video packets in a two-dimensional packet buffer, the two dimensional packet buffer including a plurality of priority sub-queues, discarding a stored volumetric data packet from a randomly selected priority sub-queue, of the plurality of priority sub-queues, in response to receiving a further volumetric video packet and the two-dimensional packet buffer being full, and transmitting a volumetric video packet from the two-dimensional packet buffer to a client device.

According to at least one example embodiment, each priority sub-queue of the plurality of priority sub-queues may correspond with a respective segment of the volumetric video.

According to at least one example embodiment, the method may further include transmitting the volumetric video packet from the two-dimensional packet buffer to the client device based on a sub-queue priority received from the client device.

According to at least one example embodiment, the sub-queue priority may be based on a field of vision of a user.

According to at least one example embodiment, the method may further include discarding the stored volumetric video packet based on a circular sampling buffer.

According to at least one example embodiment, the method may further include storing a received volumetric video packet in a priority sub-queue, of the plurality of priority sub-queues, corresponding with a sub-queue priority of the volumetric video packet, and adding an entry to the circular sampling buffer corresponding with the received volumetric video packet.

According to at least one example embodiment, the priority sub-queue may be a priority linked list, and the method may further include storing the received volumetric video packet in the priority linked list according to a scene priority level of the volumetric video packet.

According to at least one example embodiment, the method may further include, in response to receiving the further volumetric video packet and the two-dimensional packet buffer being full, randomly selecting an entry from a circular sampling buffer, discarding a lowest priority volumetric video packet from a priority sub-queue of the plurality of priority sub-queues corresponding with a sub-queue priority of the selected entry, and discarding an entry from the circular sampling buffer corresponding with the discarded volumetric video packet.

At least one example embodiment provides a method for displaying volumetric video, the method including determining a sub-queue priority based on a field of view of a user, transmitting the sub-queue priority to an apparatus having a two-dimensional packet buffer including a plurality of priority sub-queues, each of the plurality of priority sub-queues including a plurality of volumetric video packets of a volumetric video, receiving, from the apparatus, volumetric video packets from one or more of the plurality of priority sub-queues based on the sub-queue priority, and displaying the volumetric video based on the volumetric video packets

At least one example embodiment provides a computer program, computer program product including a computer program or a non-transitory computer-readable storage medium storing computer-readable instructions that, when executed, cause one or more processors to cause an apparatus to perform a method for transmitting volumetric video, the method including receiving a plurality of volumetric video packets of the volumetric video, storing the plurality of volumetric video packets in a two-dimensional packet buffer, the two dimensional packet buffer including a plurality of priority sub-queues, discarding a stored volumetric data packet from a randomly selected priority sub-queue, of the plurality of priority sub-queues, in response to receiving a further volumetric video packet and the two-dimensional packet buffer being full, and transmitting a volumetric video packet from the two-dimensional packet buffer to a client device.

At least one example embodiment provides a computer program, computer program product including a computer program or a non-transitory computer-readable storage medium storing computer-readable instructions that, when executed, cause one or more processors to cause a client device to perform a method for displaying volumetric video, the method including determining a sub-queue priority based on a field of view of a user, transmitting the sub-queue priority to an apparatus having a two-dimensional packet buffer including a plurality of priority sub-queues, each of the plurality of priority sub-queues including a plurality of volumetric video packets of a volumetric video, receiving, from the apparatus, volumetric video packets from one or more of the plurality of priority sub-queues based on the sub-queue priority, and displaying the volumetric video based on the volumetric video packets.

At least one example embodiment provides an apparatus including a means for receiving a plurality of volumetric video packets of the volumetric video, a means for storing the plurality of volumetric video packets in a two-dimensional packet buffer, the two dimensional packet buffer including a plurality of priority sub-queues, a means for discarding a stored volumetric data packet from a randomly selected priority sub-queue, of the plurality of priority sub-queues, in response to receiving a further volumetric video packet and the two-dimensional packet buffer being full, and a means for transmitting a volumetric video packet from the two-dimensional packet buffer to a client device

At least one example embodiment provides a client device including a means for determining a sub-queue priority based on a field of view of a user, a means for transmitting the sub-queue priority to an apparatus having a two-dimensional packet buffer including a plurality of priority sub-queues, each of the plurality of priority sub-queues including a plurality of volumetric video packets of a volumetric video, a means for receiving, from the apparatus, volumetric video packets from one or more of the plurality of priority sub-queues based on the sub-queue priority, and a means for displaying the volumetric video based on the volumetric video packets.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 is a block diagram illustrating an example system according to example embodiments.

FIG. 2 is a block diagram illustrating an example apparatus according to example embodiments.

FIG. 3 is a logical representation of an example packet lake according to example embodiments.

FIG. 4A illustrates an example of a field-of-view (FoV) spatial segment mapping.

FIG. 4B illustrates an example of a distance spatial segment mapping.

FIG. 4C illustrates an example of FoV and distance spatial segment mapping.

FIG. 5 illustrates an example of a packet lake control plane according to example embodiments.

FIG. 6 illustrates an overview of a two-phase congestion control algorithm (CCA) according to example embodiments.

FIG. 7 illustrates an example packet lake header format for downlink and uplink transmission according to example embodiments.

FIG. 8 illustrates an example of a subqueue of a packet lake according to example embodiments.

FIG. 9A is an example enqueuing algorithm according to example embodiments.

FIG. 9B is an example dequeuing algorithm according to example embodiments.

FIG. 10 illustrates a sampling buffer according to example embodiments.

FIG. 11 is a flowchart illustrating a method according to example embodiments.

FIG. 12 is a flowchart illustrating a method according to example embodiments.

FIG. 13 is a flowchart illustrating a method according to example embodiments.

FIG. 14 is a flowchart illustrating a method according to example embodiments.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

It should be understood that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments whether or not explicitly described. It shall be understood that although the terms “first,” “second” and the like may be used herein to describe various elements, these elements should not be limited by these terms. These terms are only used to distinguish one element from another.

For the purposes of the present disclosure, the phrases “at least one of A or B”, “at least one of A and B”, and “A and/or B” means (A), (B), or (A and B). For the purposes of the present disclosure, the phrase “A, B, and/or C” means (A), (B), (C), (A and B), (A and C), (B and C), or (A, B, and C).

Embodiments described may be implemented in a communications network, such as any of the following radio access technologies (RATs): World-wide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and enhanced LTE (eLTE), 5G (also called NR), or any future RAT such as 6G. Moreover, communication within the communications network may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), and/or Discrete Fourier Transform spread OFDM (DFT-s-OFDM).

As used herein, the term “network device” or “network node” refers to a node in a communications network via which user equipment may access the network and/or which is capable of controlling radio communication and managing radio resources within a cell. The network node or network device may be referred to as a base station (BS), an access point (AP) or an access node. The network device may be, depending on the applied technology, for example, a node B (NodeB or NB), an evolved NodeB (eNodeB or eNB), an NR NB (also referred to as a gNB), a Remote Radio Unit (RRU), a radio head (RH), a remote radio head (RRH), a relay, an Integrated Access and Backhaul (IAB) node, a low power node, a non-terrestrial network (NTN) or non-ground network device such as a satellite network device, a low earth orbit (LEO) satellite and a geosynchronous earth orbit (GEO) satellite, or an aircraft network device.

Moreover, in connection of split radio access network (RAN), the network device may refer to a centralised unit (CU) of a base station and/or a distributed unit (DU) of a base station. An interface between CU and DU may be referred to as an F1 interface in NR. In the split RAN architecture, node operations may be carried out, at least partly, in the central/centralized unit, CU, (e.g. server, host or node) operationally coupled to the DU, (e.g. a radio head/node). One CU may control one or more DUs, acting at least as transmit/receive (Tx/Rx) nodes. In some embodiments, the DUs may comprise e.g. a radio link control (RLC), medium access control (MAC) layer and a physical (PHY) layer, whereas the CU may comprise the layers above RLC layer, such as a packet data convergence protocol (PDCP) layer, a radio resource control (RRC) and an internet protocol (IP) layers. Other functional splits are possible too. In practice, any processing task may be performed in either the CU or the DU and the boundary where the responsibility is shifted between the CU and the DU may depend on the applied implementation.

The term “terminal device” refers to any end device that may be capable of wireless communication. By way of example, a terminal device may be referred to as a communication device, user equipment (UE), a Subscriber Station (SS), or a Mobile Station (MS). The terminal device may include a mobile phone, a cellular phone, a smart phone, voice over IP (VoIP) phones, wireless local loop phones a tablet, a wearable terminal device, a personal digital assistant (PDA), portable computers, desktop computer, image capture terminal de-vices such as digital cameras, gaming terminal devices, music storage and play-back appliances, vehicle-mounted wireless terminal devices, USB dongles, an Internet of Things (IoT) device, a watch or other wearable, a head-mounted dis-play (HMD), a vehicle, a drone, a medical device and applications (e.g., remote surgery), an industrial device and applications (e.g., a robot and/or other wire-less devices operating in an industrial and/or an automated processing chain contexts), a consumer electronics device, a device operating on commercial and/or industrial wireless networks, and the like.

A term “resource”, as used herein, may refer to radio resources in time domain, in frequency domain, in space domain, and/or in code domain. Some examples of resources include e.g. a physical resource block (PRB), a radio frame, a subframe, a time slot, a sub-band, a frequency region, a sub-carrier, a beam, etc. The term “transmission” and/or “reception” may refer to wirelessly transmitting and/or receiving via a wireless propagation channel on radio re-sources.

Real-time volumetric video events is a rapidly growing paradigm of real-time immersive Extended Reality (XR) experiences. Unlike traditional broadcasts, which offer a fixed perspective, live volumetric video allows audiences to experience events as if they were physically present, providing a 360-degree, immersive experience alongside in-person attendees. Viewers (e.g., users) can choose their viewpoints, zoom in on specific actions, or enjoy a panoramic view of the entire volumetric arena. This level of interactivity and immersion creates a more personalized and engaging experience, transforming how audiences consume real-time entertainment.

One of the more demanding requirements for maintaining the illusion of seamless realism in MR/XR experiences is achieving a 20 ms Motion-to-Photon (MtP) response time. This rapid response time (RTT) ensures that user movements are instantaneously reflected in the virtual environment, reducing or preventing motion sickness and enhancing the sense of immersion. When a user changes his/her field-of-view within the 3D environment, 3D video data must be downloaded, processed and rendered within the 20 ms MtP window.

This latency challenge is particularly problematic given the latency cliff effect in typical network architectures. Consider a user on a mobile device participating in a real-time XR experience. Broadly speaking, the volumetric video captured at the source traverses the core internet architecture (the “core”) before reaching the cellular network infrastructure (the “edge”) where it is delivered to the mobile user over a last-hop wireless interface. These two network segments (“core” and “edge”) have distinctly different characteristics.

The core network typically has high bandwidth and high latency connectivity. For example, careful selection of Azure regions on a multi-region path can achieve an end-to-end throughput of over 10 Gbps, while RTTs between regions can be over 300 ms.

Conversely, the edge network is characterized by lower bandwidth and low latency connectivity. For example, real-world measurements show that median 5G throughput is about 100 Mbps, while latency focused standards such as 5G Ultra-Reliable Low Latency Communications (URLLC) has a maximum data and control plane latency of 1 and 10 ms, respectively. The delivery of real-time volumetric data is therefore fundamentally unable to respond to user changes within the MtP deadline, outside of even highly curated network architectures.

Content delivery networks (CDNs) are an oft-used caching mechanism for 2D video streams. In a typical CDN, the source video is sent and cached at the CDN with a high ingress bandwidth, and the possibly slower downstream clients request video chunks based on the clients' temporal viewing progress.

Traditional 2D videos have a fixed camera field-of-view (FoV) that is determined at video capture. This enables 2D video streams to have a one-dimensional temporal domain: all frames belonging to the same 2D stream are known a priori and are strictly ordered in time. With a known frame sequence order, cache misses at the CDN can be minimized, thus improving the performance of the CDN due to the reduced need to fetch missed data from the source.

However, volumetric video is typically streamed using foveated techniques where only the environment within the FoV of the user is streamed. The sequence of video data that is transmitted is thus user-directed. This leads to complex access patterns at the CDN that are difficult to predict (and thereby cache) accurately, thus reducing CDN performance.

Furthermore, volumetric videos have to be updated within the MtP threshold in response to the user's dynamic FoV changes. However, production live video CDNs have a response time of up to 400 ms, which is already too slow for XR experiences. These live video CDNs are also typically located in the core network rather than in the mobile edge, and thus cannot completely eliminate the effects of long network latency.

Example embodiments disclose a two-dimensional packet buffer including multiple cooperating packet subqueues. The two-dimensional packet buffer may be referred to herein as a packet lake (PL).

Instead of utilizing an application-layer CDN, example embodiments use networking primitives (e.g., packet lakes) directly to enable line-rate caching and delivery of XR data sessions.

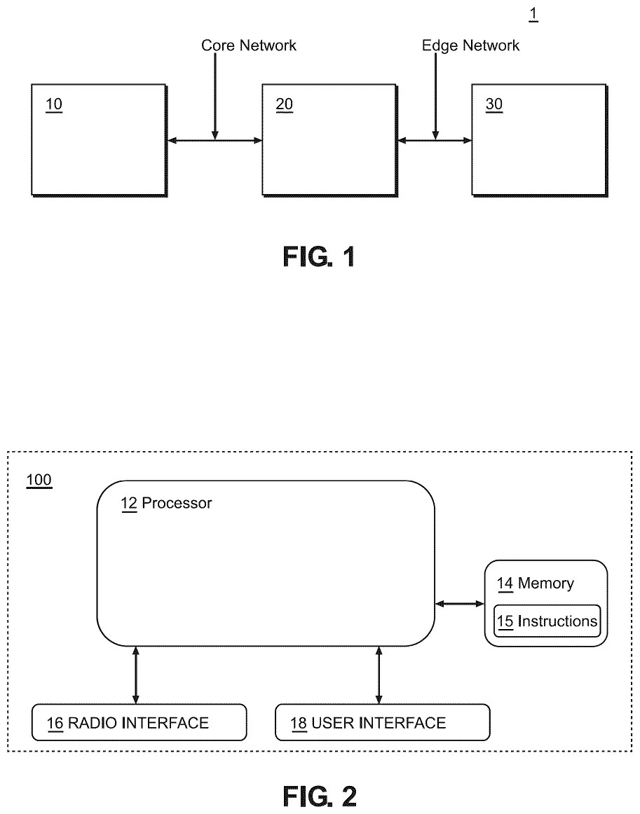

FIG. 1 is a block diagram illustrating an example system according to example embodiments.

Referring to FIG. 1, a system 1 according to example embodiments includes an origin server 10, an edge server 20 (also referred to as a switch 20 and/or an edge switch 20) and/or one or more user equipments (UEs) 30. The origin server 10 may be a content delivery server. For example, the origin server 10 may provide (e.g., transmit) XR video to an edge server 20 for distribution to a UE 30. The XR video may be and/or may be included in real-time volumetric video events. The edge server 20 may be or may be included in, for example, a network node (e.g., an eNB). However, example embodiments are not limited to this example. Rather, the edge server 20 may be, for example, an access point, a wireless router, etc. The UE 30 may be, for example, a head-mounted display (HMD). However, example embodiments are not limited to this example and the UE 30 may be any device capable of displaying XR video content.

FIG. 2 shows, by way of example, a block diagram of an apparatus 100. The apparatus 100 comprises, for example, at least one processor 12 and at least one memory 14 storing instructions 15 that, when executed by the at least one processor, cause the apparatus 100 at least to perform the method or methods as disclosed herein, and any of the embodiments thereof. In an example, the at least one memory and the instructions (e.g. a computer program code, software, etc.), are configured, with the at least one processor, to cause the apparatus 100 to perform the method or methods as disclosed herein, and any of the embodiments thereof.

A processor 12 may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a user equipment, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example, and if applicable to the particular claim element, a baseband integrated circuit or processor integrated circuit for a mobile device or a similar integrated circuit in server, a cellular network device, or other computing or network device.

The memory 14 may be implemented using any suitable data storage technology. The memory may comprise a database for storing data. The memory 14 may be at least in part external to apparatus 100 but accessible to apparatus 100.

The instructions 15 may be comprised in a computer readable medium or a non-transitory computer readable medium. The term non-transitory, as used herein, is a limitation of the medium itself (i.e. tangible, not a signal) as opposed to a limitation on data storage persistency (e.g. random access memory (RAM) vs. read only memory (ROM)).

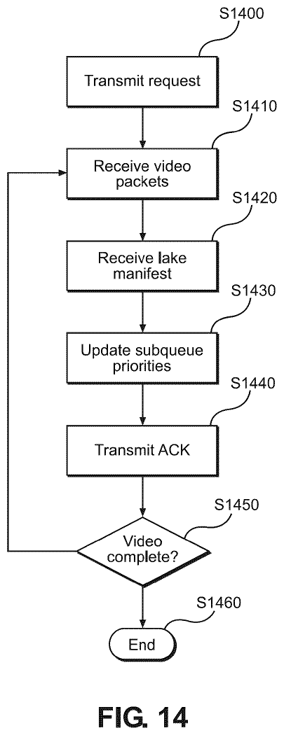

For example, the apparatus 100 may be a terminal device, such as the UE 30 of FIG. 1. As another example, the apparatus is comprised in such a terminal device, e.g. as a chipset configured to control the terminal device. The apparatus 100 may be caused or configured to perform at least the method of FIG. 14 and/or any one or more of the embodiments described.

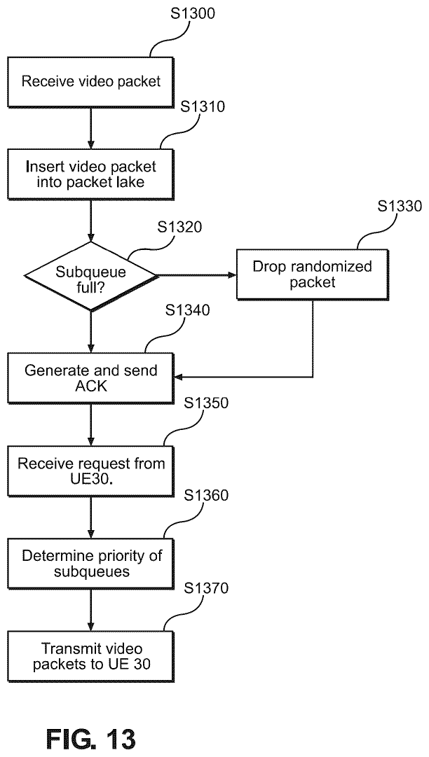

As another example, the apparatus 100 may be a network node, e.g. the edge server 20 of FIG. 1. In another embodiment, the apparatus 100 is comprised in such a network node, e.g. as a chipset configured to control the network node. The apparatus 100 may be caused or configured to perform at least the method of FIG. 13 and/or any one or more of the embodiments described.

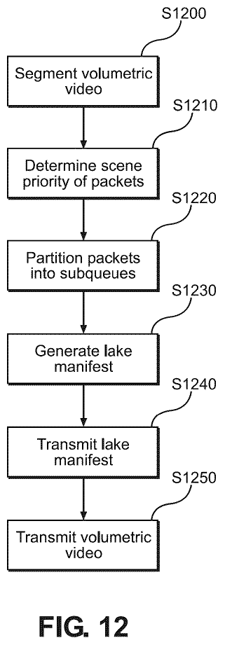

As another example, the apparatus 100 may be a server, e.g. the origin server 10 of FIG. 1. In another embodiment, the apparatus 100 is comprised in such a server, e.g. as a chipset configured to control the server. The apparatus 100 may be caused or configured to perform at least the method of FIGS. 11-12 and/or any one or more of the embodiments described.

The apparatus may comprise one or more entities of any of protocol layers, such as a MAC entity, an RRC entity, an RLC entity, a PDCP entity or a PHY entity. In some embodiments, the entity is configured to perform at least the method of FIGS. 11-12, FIG. 13, and/or FIG. 14, and/or any one or more of the embodiments described.

The apparatus 100 comprises a radio interface 16. The radio interface 16 may provide the apparatus 100 with communication capabilities. The radio interface 16 may comprise a receiver configured to receive information in accordance with at least one cellular or non-cellular standard. The radio interface 16 may comprise a transmitter configured to transmit information in accordance with at least one cellular or non-cellular standard. The receiver may comprise more than one receiver. The transmitter may comprise more than one transmitter. The radio interface 16 may comprise a transceiver configured to receive and transmit information in accordance with at least one cellular or non-cellular standard. The transceiver may comprise more than one transceiver.

The apparatus 100 may comprise a user interface 18 comprising, for example, at least one of a keypad, a microphone, a touch display, a display, a speaker, etc. The user interface 18 may be used to control the apparatus by the user. The user interface 18 may be external to the apparatus 100. For example, the apparatus 100 may be connected to another device, such as a computer, either via wireless or wired connection, and the apparatus 100 is controlled by the user via the computer.

In an embodiment, at least some of the processes described herein may be carried out by an apparatus comprising means for carrying out at least some of the described processes. Means for performing method steps as disclosed herein may include software and/or hardware components of the apparatus 100. For example, the at least one processor 12, the memory 14, and the computer program code form means for carrying out the method or methods as disclosed herein, and any of the embodiments thereof. As used herein the term “means” is to be construed in singular form, i.e. referring to a single element, or in plural form, i.e. referring to a combination of single elements. Therefore, terminology “means for [performing A, B, C]”, is to be interpreted to cover an apparatus in which there is only one means for performing A, B and C, or where there are separate means for performing A, B and C, or partially or fully over-lapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

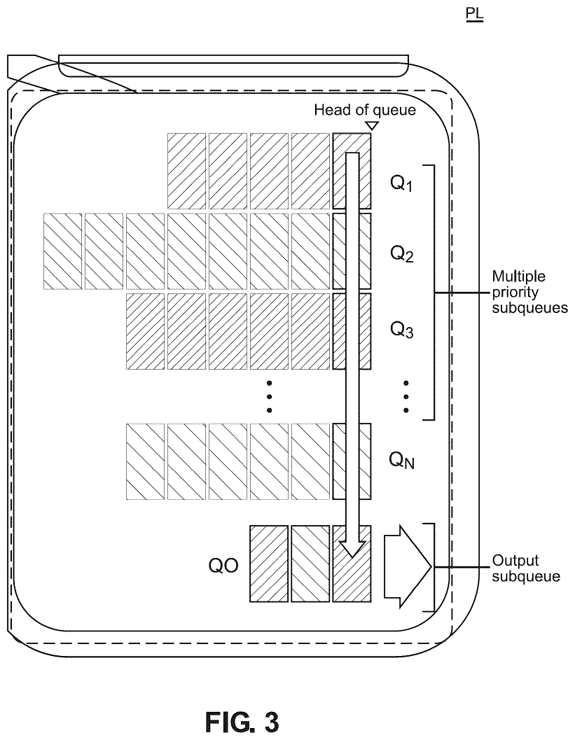

FIG. 3 is a logical representation of a packet lake according to example embodiments.

Referring to FIG. 3, a packet lake PL is a two-dimensional queue structure deployed in network switches (e.g., edge server 20) to build a cache at a bottleneck switch. The high bandwidth, high latency core network (e.g., between the origin server 10 and the edge server 20) is utilized to proactively fill the packet lake PL cache with XR data. The XR client (e.g., the UE 30) then dequeues a selected subset of this XR data over the lower bandwidth edge network (e.g., between the edge server 20 and the UE 30) based on the demand of its XR user context.

Packet lakes PL may be provisioned on a per-session basis, where each session between an origin server (e.g., origin server 10) and destination client (e.g., UE 30) utilizes a single packet lake PL. A single edge server 20 may support multiple packet lakes PL. For example, a single edge server 20 may concurrently manage and/or maintain multiple packet lakes PL originating from a same origin server 10 to multiple UEs 30. According to some example embodiments, a single edge server 20 may concurrently manage and/or maintain multiple packet lakes PL originating from multiple origin servers 10 to multiple UEs 30.

A packet lake PL includes N separate packet queues, referred to herein as subqueues Q. N may be any real number. For example, N may be 8. However, example embodiments are not limited to this example.

Each of these N subqueues Q in a packet lake PL represents a different segment of the volumetric video. The origin server 10 segments the 3D scene, determines a scene priority p (sometimes referred to as scene packet priority p) for different objects/regions of the scene, and encodes the scene into a sequence of packets. Given the available bandwidth between the server 10 and UE 30, the origin server 10 determines the relative bitrate of the different objects within the scene. The origin server also partitions the scenes into multiple subqueues Q, and allocates packets to each of these subqueues Q. For example, the scene priority p may be different for different objects/regions in a scene and different scene priorities p may be assigned to different packets allocated to a particular subqueue Q.

At the UE 30, a subqueue priority P of the subqueues Q sets the order in which packets from subqueues Q are retrieved when forwarding packets from the edge server 20 to the UE 30. For example, the subqueue priority P may be different for different subqueues Q. The subqueue priority P of a particular subqueue Q may be assigned based on a request from the UE 30.

Packets in subqueues Q with higher subqueue priority P are transmitted before those in subqueues Q with a lower subqueue priority P. The subqueue priority P is determined by the UE 30 and is independent of the origin server 10. The UE 30 updates the subqueue priority P based on a user-specified context (e.g. a user state, for example, the FoV of the user). The UE 30 also updates the origin server 10 with the user state to enable adaptation of encoder states, such as scene prioritization and/or subqueue Q allotment.

Packet lakes PL differ from traditional networking primitives in that packet lakes PL allow applications direct influence over its operation. For example, an application running on the UE 30 may directly influence the operations of the packet lake PL maintained at the edge server 20.

To use packet lakes PL for XR distribution, the XR video is partitioned into multiple spatial segments. These spatial segments are not necessarily static and can change depending on the XR user's interaction with the XR content. The origin server 10 may send a lake manifest to the UE 30. The lake manifest describes the mapping between the spatial segments and the subqueues Q. The UE 30 uses the lake manifest to guide its decision on the subqueue priority P of the packet lake subqueues Q.

The UE 30 may periodically transmit a client state to the origin server 10 to update the origin server 10 on a state of the XR client application (e.g. the FoV of the user, mobility details, and/or interaction with the XR environment, etc.). The transmission of the client state to the origin server 10 may be application specific. For example, the UE 30 may transmit the client state to the origin server according to an application-defined mechanism. For example, an application running on the UE 30 may determine when the UE 30 transmits the client state to the origin server. The origin server 10 can then update the lake manifest, if necessary, in response to the received client state.

A packet lake PL may include an output subqueue QO. The edge server 20 may dequeue packets from the subqueues Q to the output subqueue QO for transmission to the UE 30 based on the subqueue priorities P and the scene priorities p of the packets. For example, the edge server 20 may dequeue the packets according to a proportional scheduling algorithm or an ordered scheduling algorithm. The dequeuing of packets will be discussed in more detail below.

According to example embodiments, the mapping of the spatial segments to subqueues Q may be application specific. Some examples of spatial segment mapping are discussed below. However, example embodiments are not limited to these examples.

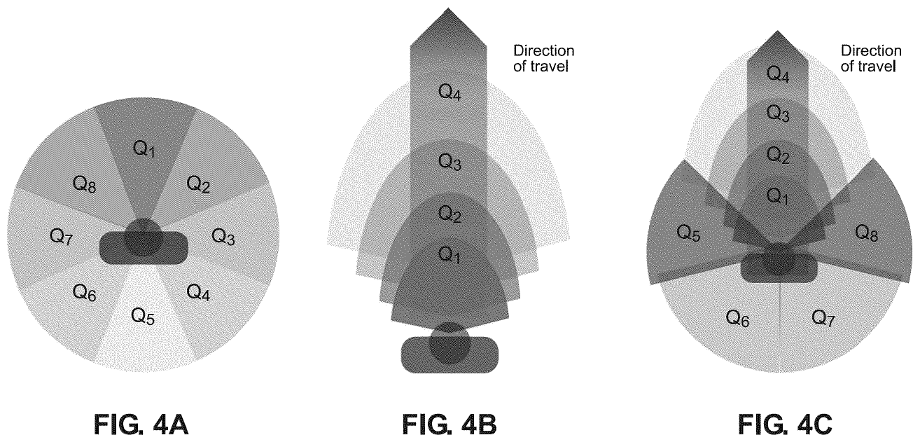

FIG. 4A illustrates an example of a field-of-view spatial segment mapping.

FIG. 4B illustrates an example of a distance spatial segment mapping.

FIG. 4C illustrates an example of FoV and distance spatial segment mapping.

If a user is static and only looking from side-to-side, the XR world (e.g., the XR video content) can be partitioned along its field-of-view, with each segment spanning a non-overlapping angular range. Each segment can then be mapped to one subqueue Q as shown in FIG. 4A. The XR client will configure subqueue priorities P such that the subqueue Q that overlaps the most with its local FoV will be assigned the highest subqueue priority P. As the user looks from side to side, the subqueue priorities P will be changed such that the UE 30 downloads packets from the subqueue Q that is most relevant to the user's local FoV, at reduced or minimal latency (e.g., no greater than the latency of the edge network).

In XR environments with higher dynamism, distance intervals can be mapped to segments, as illustrated in FIG. 4B. When using distance spatial segmenting, the UE 30 switches between subqueues Q depending on how quickly the user moves through the XR world. Meanwhile, the origin server 10 updates the lake manifest and/or the subqueue/cache contents for areas even further away. The latency of the packet lake PL cache updates for further-out areas may therefore be hidden from the XR user who is exploring areas closer to him/herself. A more complex XR experience may even combine caching techniques for both static and mobile scenes as shown in FIG. 4C.

Because packet lakes PL may be used in scenarios where the end-to-end latency cannot be accommodated within the MtP limit, packet lakes PL according to example embodiments are designed for point cloud-based volumetric video streams that are loss tolerant. A point cloud is a 3D version of an image. Each point in a point cloud specifies an (x,y,z) position, as well as the color at that position. Each point in the point cloud is rendered independently of the others.

According to some example embodiments, point cloud packets lost in transit may not be retransmitted. The lost point cloud packet may either be recovered or accommodated at the end-user decoder/renderer. For example, a loss of any point (e.g., point cloud packet) may not invalidate the entire point cloud. The end-user decoder/renderer may render the rest of the points that it possesses without the missing points/point cloud packets.

Within each segment (e.g., each subqueue Q), packet lakes PL support a finite number of scene priorities p. This provides the origin server 10 with the capability to utilize scene priority levels p in organizing and transmitting 3D data. For example, a scene can be partitioned into dynamic vs. static regions, or foreground vs. background objects, with dynamic foreground objects assigned a higher scene priority p as they will be the focus of the user experience. Packets received by the edge server 20 in each subqueue Q are sorted by this scene priority p. When dequeuing a packet for the UE 30, higher scene priority p packets are preferred. The scene packet priorities p are fixed at the origin server 10 and are distinct from the subqueue priorities P set by the UE 30.

The priority assignments by the server 10 to different spatial regions influences the distribution of scene packet priorities p in the transmitted volumetric stream. Packets in each subqueue Q are cached (e.g., by the edge server 20) such that the distribution of cached scene packet priorities p closely tracks the priority distribution of ingress packets. In the event that a new packet arrives at a full subqueue Q, the edge server 20 selects a cached priority level with a probability that is proportional to its relative arrival rate and discards the oldest packet within that priority level to make room for newly arriving packets. This has the effect of retaining cached packets with the ingress priority distribution. A method for determining and discarding (e.g., dropping) a packet by the edge server 20 will be described in more detail later.

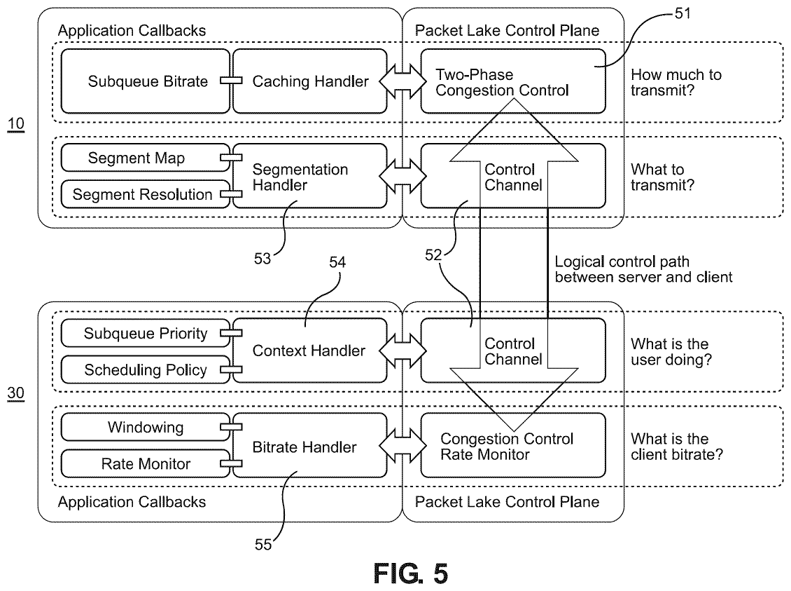

FIG. 5 illustrates an example of a packet lake control plane according to example embodiments.

The packet lake PL control plane regulates the rate at which packets flow between the server 10 and the UE 30. Because packet lakes PL are not transparent to the origin server 10 and/or the UE 30, flow control over a packet lake PL requires input from both the transport and application layers. According to some example embodiments, congestion control algorithms (CCAs) and caching policies are enforced through a series of application-specific packet lake PL handlers.

Referring to FIG. 5, the control plane includes two control loops: a two-phase congestion control algorithm 51 that governs end-to-end throughput between the server 10 and the UE 30; and a control channel 52 that coordinates application states between the server 10, the edge server 20, and the UE 30.

The lake manifest and client states are exchanged over the control channel 52. At the origin server 10, the lake manifest is defined by a segmentation handler 53. The segmentation handler 53 defines the segment map that specifies the spatial region of the volumetric video that is mapped to each subqueue Q, and the segment resolution of each corresponding spatial region.

For example, with the mapping of FIG. 4B, the origin server 10 may utilize N=4 subqueues Q for distance segments, with the first subqueue Q1 mapped to nearby objects at a higher resolution than the fourth subqueue Q4 mapped to distant objects.

A context handler 54 at the UE 30 uses the lake manifest to specify the subqueue priority P that defines the relative importance of the subqueue Q, and a scheduling policy used when dequeuing packets from these subqueues Q of different priorities P.

For example, referring to FIG. 4B, the UE 30 may define a subqueue priority P of 4, 3, 2, 1 to subqueues Q1 to Q4, respectively, and a proportional scheduling policy such that in every group of 10 packets, the UE 30 receives (from the edge server 20) 4 packets from subqueue Q1 (assigned a subqueue priority P of 4), 3 packets from subqueue Q2 (assigned a subqueue priority P of 3), 2 packets from subqueue Q3 (assigned a subqueue priority P of 2), and 1 packet from subqueue Q4 (assigned a subqueue priority P of 1).

According to some example embodiments, packet lakes PL support an ordered scheduling policy where only packets from a highest priority non-empty subqueue Q are dequeued (e.g., transmitted from the edge server 20 to the UE 30).

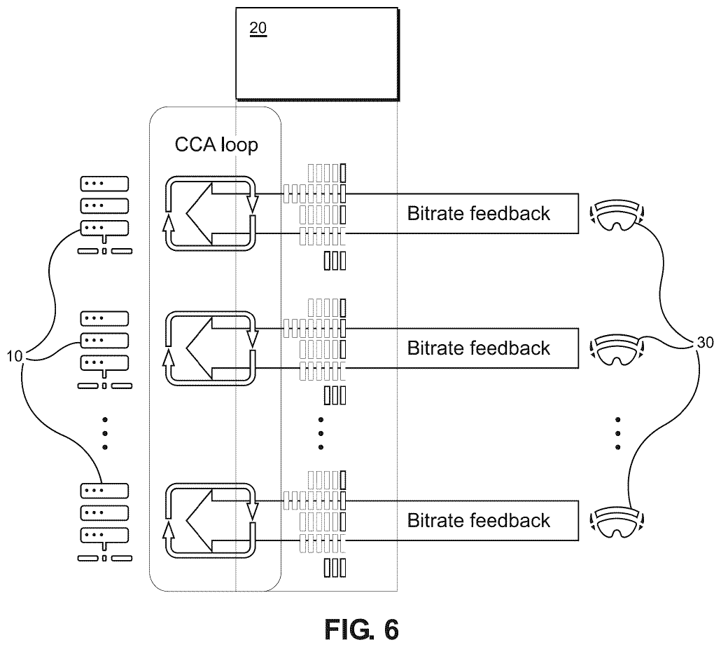

FIG. 6 illustrates an overview of a two-phase CCA according to example embodiments.

The two-phase control algorithm 51 regulates the bitrate between each server 10-UE 30 pair. In the first phase, the server 10 runs a CCA loop on a server 10 to edge server 20 link to estimate a share of core network bandwidth available for the server 10. The edge server 20 assists in this loop by generating an ACK message for each received packet.

In the second phase, the server 10 receives bitrate feedback from the UE 30, denoting the effective bandwidth seen at the UE 30. The resulting throughput from the server 10 should be no greater than N (the total number of subqueues Q) times this effective bandwidth.

Returning to FIG. 5, the UE 30 uses a bitrate handler 55 to measure and report its XR edge bandwidth to the server 10. Concurrently the edge server 20 provides feedback to the server 10 on each packet received at the edge server 20. A caching handler 56 at the server 10 uses these two feedback signals (i.e. packet ACKs from the edge server 20 and bandwidth reports from the UE 10) to determine the available bandwidth to the edge server 20. This available bandwidth is shared across the different XR segments in a manner consistent with the segmentation handler function.

Packet lake PL frames (e.g., packets) may be transmitted over a UDP stream at a well-defined UDP port. Packet lake PL UDP packets utilize application layer headers that may be interpreted by the edge server 20. The application layer headers may be relatively small (e.g., maximum of 18 bytes) and incur minimal overhead. For example, a maximum number N of subqueues Q may be 8 for a balance between programming flexibility and implementation overhead, which is sufficient to cover diverse XR use cases such as those shown in FIGS. 4A-4C. However, example embodiments are not limited to this example. According to some example embodiments, packet lake PL streams may utilize UDP packets for inline control flow.

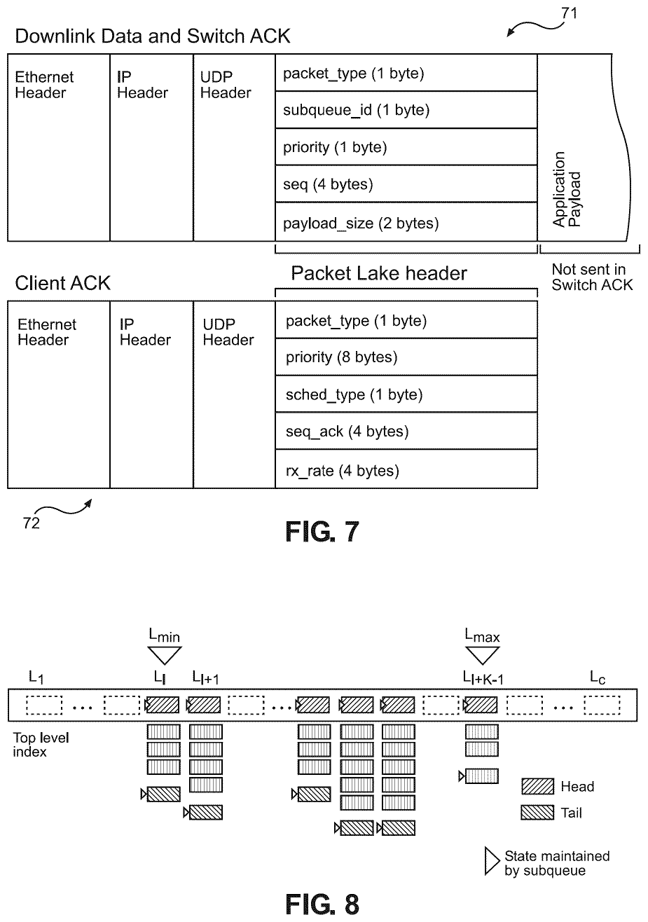

FIG. 7 illustrates an example packet lake header format for downlink and uplink transmission, according to example embodiments.

Downlink packet lake packets 71 (e.g., frames) from the server 10 to the UE 30 include a relatively small packet lake PL header in the UDP payload, as shown in FIG. 7. The packet lake PL header is both interpreted by the edge server 20 and included in a packet forwarded to the UE 30. The packet lake PL header may include a packet type, an ID of the subqueue Q that this packet should be placed (subqueue_id), a scene priority p of the packet within that subqueue Q (priority), and/or a size of the remaining payload (payload_size). The server 10 may assign a unique sequence number (seq) to every transmitted packet.

The edge server 20 generates an uplink switch ACK message 71 for every packet received from the server 10, to enable CCA between the server 10 and the edge switch 20. This uplink switch ACK message 71 is generated by cloning the received downlink packet, removing the payload, and updating the payload size accordingly (e.g., payload_size=0). The edge server 20 may transmit the uplink switch ACK message 71 to the server 10 in response to receiving a downlink packet from the server 10.

The UE 30 may generate an uplink client ACK 72 to notify the server 10 of a received packet and to update subqueue priorities P on a packet lake PL stored at the edge server 20. The client ACK 72 includes the packet type, an array of N (e.g., N=8) subqueue priorities P (priority), a unique sequence number of the client ACK 72 (seq_ack), and/or the downlink bitrate seen at the UE 30 (rx_rate). The UE 30 may transmit the client ACK 72 to the server 10 via the edge server 20.

The edge server 20 may reconfigure subqueue priorities P on a packet lake PL based on the priority array (priority) in the client ACK 72. The edge server 20 may forward the client ACK 72 to the server 10. The rx_rate may be used by the CCA between the server 10 and the UE 30. The UE 30 may specify a dequeuing scheduling policy (discussed in more detail below) in sched_type, which is neither proportional nor ordered.

According to some example embodiments, a UE 30 to edge server 20 control plane may be implemented via separate control messages from the UE 30 to the edge server 20, instead of including such information in the client ACK 72. This may simplify switch processing in situations where client updates are less frequent.

FIG. 8 illustrates an example of a subqueue of a packet lake according to example embodiments.

The subqueues Q are on the critical data path of the edge server 20 and dequeuing and/or enqueuing latencies may have a significant impact on the overall performance of the packet lake PL. Each subqueue Q has a buffer for M packets, where M is selected to be greater than or equal to a product of the one-way latency between the server 10 and the edge server 20 t_{s2sw} and the bandwidth (e.g., bitrate) between the edge server 20 and the UE 30 b_{sw2c} divided by a maximum transmission unit MTU indicating a largest allowable packet size on the network including all header information and payload. For example, M may be selected according to Equation 1.

$$M \geq {t}_{s 2 sw} * \frac{{b}_{sw 2 c}}{MTU} \qquad \underline{Equation 1}$$

According to some example embodiments, the edge server 20 may maintain subqueues Q of a priority lake PL to maintain a priority queue of arriving packets, and to ensure that the priority distribution of the cached packets closely follow the distribution emitted by the server 10. This means that, unlike traditional priority queues, edge server 20 cannot merely drop low priority tail packets from a full subqueue Q to make room for incoming packets. Edge server 20 must allow packets of a subqueue Q from selected scene priority p levels to be discarded, even if those packets are not at the tail end of the subqueue Q.

Referring to FIG. 8, a number of scene priority levels p may be limited. For example, the number of scene priority levels p may be limited to 128. However, example embodiments are not limited to this example. The maximum number of scene priority levels p (e.g., the highest scene priority level p) may be indicated as C. A subqueue Q may be organized as an array of C linked-lists L. Each subqueue Q includes an array entry including a head and a tail of each linked-list L₁-L_{C}. The subqueue Q also includes (e.g., includes pointers to) a lowest priority non-empty linked-list Lₘᵢₙ and a highest priority non-empty linked-list Lₘₐₓ.

For example, referring to FIG. 8, Lᵢ is indicated as the minimum non-empty linked list Lₘᵢₙ. The linked list Lᵢ includes 5 packets of scene priority pᵢ. A top packet of the linked list Lᵢ is indicated as a head of the linked list Lᵢ and a bottom packet of the linked list Lᵢ is indicated as a tail of the linked list Lᵢ.

When a packet arrives at a full subqueue Q, a packet from one of these linked lists L, with associated priority p, is dropped. For example, let 1 be the length of the linked list Lᵢ, and

$$G = {\sum }_{j = 1}^{c} {l}_{j}$$

be the total number of packets in the subqueue Q. In order to achieve the required caching distribution, the probability of selecting any particular linked list L is δ=1/G. The oldest packet in this selected linked list L is dropped. The implementation of this drop algorithm is discussed in further detail below.

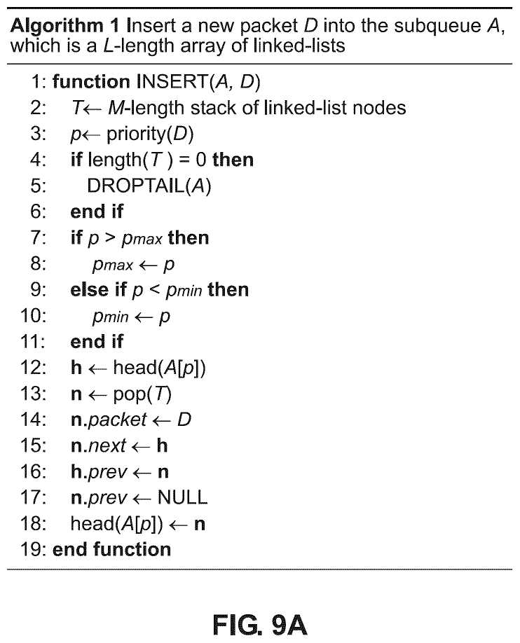

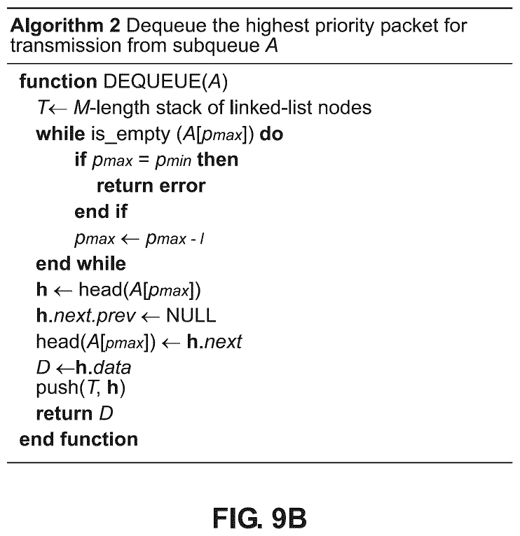

FIG. 9A is an example enqueuing algorithm according to example embodiments.

Each subqueue Q has a maximum of M linked-list nodes. When the edge server 20 receives a new packet for a subqueue Q, it reads the scene priority p of the packet and directly indexes into the array to obtain the associated linked list L. The edge server 20 retrieves a new linked-list node, adds a pointer to the packet to the node, and adds the new node to the corresponding linked list L of the subqueue Q (e.g., enqueues the packet). According to some example embodiments, the memory access of the enqueuing operation exhibits relatively high locality and runs in O(1) time with a small number of compare and assignment operations. This allows for extremely fast enqueuing, for example well under 100 ns. Similar optimizations are applied to the dequeuing algorithm.

FIG. 9B is an example dequeuing algorithm according to example embodiments.

Packets are dequeued (e.g., transmitted to the UE 30 and removed from the packet lake PL) from a subqueue Q starting from packets with the highest priority linked list L, pointed to by Lₘₐₓ. If there are multiple packets (i.e. the linked list size is greater than one), then the latest enqueued packet, at the head of the linked list, is dequeued (e.g., moved to the output subqueue QO for transmission to the UE 30).

The edge server 20 may use a sampling buffer 1000 to determine a linked list L from which packets are to be dropped. For example, the edge server 20 may maintain a sampling buffer 1000 for each subqueue Q.

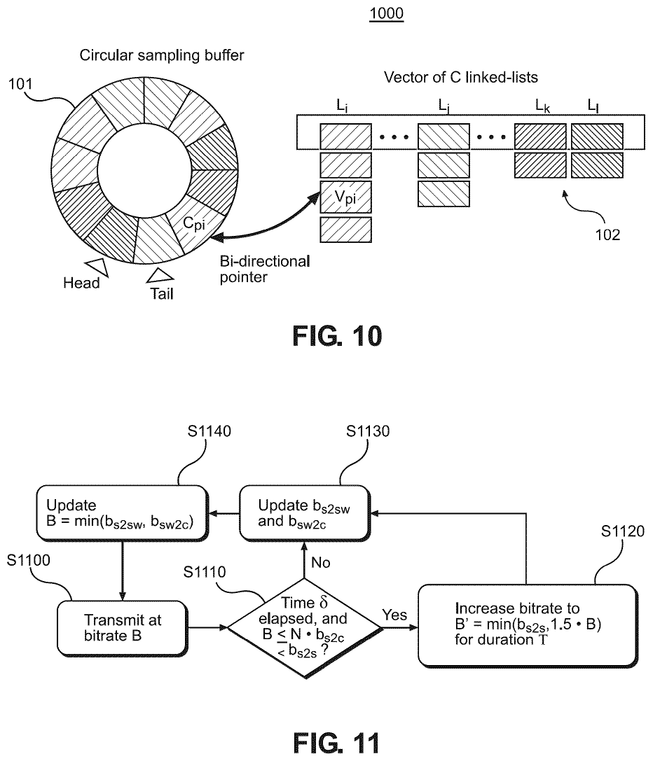

FIG. 10 illustrates a sampling buffer according to example embodiments.

Referring to FIG. 10, a sampling buffer 1000 holds the same number of entries M as the associated subqueue Q. According to example embodiments, the sampling buffer 1000 may include a circular buffer 101 of size M and/or a vector of C linked-lists 102 with a total size of M entries.

When a new packet arrives, the edge server 20 records the associated scene priority p of the packet at the head of the circular buffer 101, cₚᵢ, along with a corresponding entry vₚᵢ in the vector of linked-lists 102 (e.g., in the corresponding subqueue Q). The edge server 20 maintains a bidirectional pointer between the entry vₚᵢ in vector of linked lists 102 and the entry cₚᵢ in the circular buffer 101. Thus vₚᵢ can be reached from cₚᵢ and vice versa.

The subqueues Q of the packet lake PL according to example embodiments may be implemented by the edge server 20 as a part of a software switch. For example, the edge server 20 may implement the subqueues Q as function of the processor 12 of the edge server 20. However, example embodiments are not limited to this example.

According to some example embodiments, a hardware implementation of the subqueues Q can be organized as an array of queue buffers, such as Push-In-First-Out (PIFO) queues, rather than linked-lists, along with a reduction in the number of supported priority levels L to accommodate constraints on hardware buffer availability. In such a case, a queue buffer may be allocated to each PIFO queue rather than shared across all linked-lists in the subqueue Q. Efficient hardware implementations of PIFO queues such as M-way Balanced Multi-Way (BMW) trees can then be employed to provide efficient priority caching performance.

The edge server 20 can remove packets from a subqueue Q in one of two ways: packets are dropped and discarded when the subqueue Q is full; or packets are dequeued when being forwarded to the UE 30. The use of dual data structures, a circular buffer and vector of linked lists, is used to support these two methods of updating the sampling buffer.

According to some example embodiments, when the edge server 20 determines to drop a packet (e.g., when the edge server 20 receives a new packet for a full subqueue Q), the edge server 20 may select an entry cₚᵢ from the circular buffer 101 with uniform probability (e.g., randomly). A random entry cₚᵢ from the circular buffer may be selected according to any known method.

The edge server 20 may then discard the oldest packet vₚⱼ from the linked list L of the same scene priority level p in the subqueue Q as the selected random entry cₚᵢ. The entry cₚⱼ in the circular buffer 101 and/or its corresponding vₚⱼ entries in the vector of linked lists 102 are also discarded from the sampling buffer 1000.

When a packet is dequeued from a subqueue Q, the corresponding entry of the sampling buffer 1000 is also discarded. All insertion and removal operations on the sampling buffer 1000 have constant O(1) overhead.

For example, if the edge server 20 receives a packet from the server 10 with a subqueue priority P corresponding with a subqueue Q that is full (e.g., the subqueue Q contains M packets) and having a scene priority p equal to i, the edge server 20 may insert the received packet at the head of the linked list Lᵢ. The edge server 20 may then randomly select an entry from the circular sampling buffer 101. For example, the edge server 20 may randomly select an entry from the circular sampling buffer 101 corresponding with a packet having a scene priority p equal to j (e.g., a packet in the linked list Lⱼ). In this case, the edge server 20 may drop (e.g., delete, remove, etc.) a packet from a tail of the linked-list Lⱼ and remove the corresponding entries cₚⱼ and/or vₚⱼ from the sampling buffer 1000.

Thus, according to example embodiments, packets may be dequeued/discarded from a packet lake PL such that a scene priority p of discarded packets is proportional to reception of packets with the scene priority p. Thus, in a case where a user changes a FoV (e.g., a user turns their head in a virtual reality setting), a packet lake PL according to example embodiments may include packets of differing scene priorities p for the subqueue Q corresponding to the new FoV and the edge server 20 may be able to provide a full scene of the new FoV more quickly rather than only higher priority (e.g., key frames) packets of the new FoV.

A packet lake PL according to example embodiments can have Nₘᵢₙ≤N≤Nₘₐₓ or example, Nₘₐₓ may be set to 8 to obtain a balance between providing programming flexibility to the server-client link and implementation efficiency. However, example embodiments are not limited to this example.

Packets are dequeued (i.e., transmitted to the UE 30) from the subqueues Q according to the selected scheduling policy: proportional or ordered. According to some example embodiments, the scheduling policy may be selected by the UE 30. For example, the UE 30 may indicate the selected scheduling policy in the sched_type field of the client ACK 72. For example, the UE 30 may determine the selected scheduling policy according to any known method.

Let P1, . . . , PN be the priorities of the N subqueues Q, as assigned by the UE 30. The ith subqueue priority is 1≤Pi≤Λ if the subqueue is active, or Pi=0 otherwise, where Λ≥N is the maximum integer subqueue priority P level. For example, a subqueue Q indicated by the UE 30 as having a subqueue priority P equal to 0 may be considered inactive. Packets from inactive subqueues Q are not dequeued. For active subqueues, the subqueue priorities P must be unique, i.e. Pi≠Pj for i≠j. Without loss of generality, let Pα1, Pα2, . . . , Pαk be the sorted subqueue priorities P of active subqueues Qα1, . . . , Qαk, ordered from highest (Pα1) to lowest priority (Pαk).

With proportional scheduling, the edge server 20 first dequeues Pal packets from the highest priority subqueue α1, then Pα2 packets from the next highest priority subqueue α2 and so on until subqueue αN. If any subqueue ai has fewer than Pai packets, then all packets in that subqueue are dequeued. This allows clients to receive volumetric video data from multiple spatial segments, and is useful for supporting use cases involving rapid and repeated FoV changes between segments.

With ordered scheduling, at each dequeuing opportunity, the edge server 20 dequeues a packet from the non-empty, active subqueue Q with the highest priority. The ordered policy focuses on only the most important active subqueue Q, i.e. the one that corresponds to the FoV of the client.

According to some example embodiments, edge server 20 tracks the bitrate between the server 10 and the edge server 20, along with the bitrate between the edge server 20 and the UE 30. Because the edge server 20 caches XR video at the boundary of the core and mobile edge networks, its cache is filled by the server 10 at a higher bitrate than it is emptied for the UE 30. This difference in target bandwidths (e.g., bitrates) during normal operation means that traditional end-to-end congestion control algorithms cannot determine the correct server 10 to edge server 20 bandwidth (e.g., bitrate).

According to example embodiments, a packet lake PL congestion control algorithm (PL-CCA) has two objectives: avoid congestion on the server 10 to edge server 20 link; and monitor for congestion on the edge server 20 to UE 30 link.

Even though each packet lake on the edge server 20 according to example embodiments supports only one server 10 to UE 30 link, multiple packet lakes PL can be instantiated on the server 10. The server 10 to edge server 20 link is shared with other packet lake PL and non-packet lake PL flows. Hence, the ingress bandwidth at the edge server 20 should be shared fairly across its multiple server flows.

The CCA between server 10 to edge server 20 is based on TCP bottleneck bandwidth and RRT (BBR) CCA with the end-points being the origin server 10 and the edge server 20. In this modified BBR CCA, the edge server 20 transmits packets at the rate determined by the standard BBR algorithm. Unlike the typical BBR algorithm, the PL-CCA measures the bottleneck bandwidth using the switch ACK message 71 that the edge server 20 generates in response to every packet that it receives from the server 10. The timestamps of the transmitted and corresponding ACK packets are compared to determine the bottleneck bandwidth, which is in turn used to govern the packet pacing rate at the server 10.

Volumetric video streams are loss-tolerant and the origin server does not retransmit lost packets. BBR may be used as the basis for packet lakes CCA as it is known to outperform loss-based CCAs, and because BBR does not incur sharp bandwidth variations in response to losses. BBR is thus complementary to the loss-invariant design of packet lakes transport. BBR is also a sender-based CCA, and requires minimal packet handling logic at the edge server 20. However, example embodiments are not limited to this example, For example, other CCAs such as PCC (used in WebRTC) can be utilized in place of BBR.

According to some example embodiments, the server 10 should not fill a subqueue Q at a rate quicker than the bitrate of the edge server 20 to UE 30 link. However, the server 10 cannot directly measure this bitrate because, according to example embodiments, there may not be a one-to-one mapping between the packets transmitted from the server 10 and the packets received by the UE 30. Despite this, the server 10 still needs to measure the bandwidth (e.g., bitrate) received by the UE 30 to regulate its own transmitted bitrate.

The same BBR algorithm cannot be used for determining and/or regulating the server 10 to UE 30 bandwidth and RTT estimation because the queuing delay of each packet at the edge server 20 is highly variable and unbounded. If the packets are dequeued/enqueued (e.g., transmitted from the edge server 20 to the UE 30) in lower priority subpackets, they will encounter inflated queuing delays or even be discarded to make room for higher priority packets. If BBR or other TCP-style CCAs are used, the server 10 will have to account for the additional packet queuing latency. This can be addressed by having the edge server 20 track and feedback packet queuing delays to the server 10, or have the server maintain a digital twin of the packet lake PL queue state to track every packet. However, adding tasks on the critical processing path of the edge server 20 would slow down packet processing, while maintaining a digital twin at the server 10 would impose a significant overhead.

According to some example embodiments, a lighter-weight client assisted approach for server 10 to UE 30 CCA may be employed. For example, the UE 30 may track its received bitrate and send this information back to the server 10. The rx_rate field in the client ACK packet 72 may be used for this purpose.

FIG. 11 is a flowchart illustrating a method according to example embodiments. The method shown in FIG. 11 may be performed at the server 10. For example, the method shown in FIG. 11 may be performed by the processor 12 of the server 10.

In a steady state, the transmitted throughput B of the server 10 via the edge server 20 with N subqueues Q may be calculated according to Equation 2, where b_{s2sw} is the bitrate of the server 10 to the edge server 20 and b_{sw2c} is the bitrate of the edge server 20 to UE 30.

$$B = min ( {b}_{s 2 sw} , N * {b}_{sw 2 c} ) \qquad \underline{Equation 2}$$

If the server bitrate B=b_{s2sw}, then the end-to-end throughput is bottlenecked by the server 10 to edge server 20 link. The BBR CCA used on this link has a rate probing mechanism that will respond to any increase or decrease of the available bandwidth (e.g., bitrate).

Under steady-state operations, the server 10 may continuously receive b_{sw2c} reports from the UE 30 (e.g., via the AK message 72).

Referring to FIG. 11, at S1100 the server 10 transmits video packets to the edge server 20 at a bitrate B. For example, the server 10 may compute the bitrate B according to Equation 2.

At S1110, the server 10 determines if a flow of the packet lake PL packets is limited by the edge bandwidth (e.g., the bitrate between the edge server 20 and the UE 30 b_{sw2c}) and if a time interval δ has passed since a last time that the server 10 increased the bitrate B. For example, the time interval δ may be set to 5 seconds. However, example embodiments are not limited to this example.

For example, the server 10 may determine that the flow of the packet lake PL packets is limited by the edge bandwidth b_{sw2c} if the bitrate B is less than or equal to the number N of subqueues Q times the edge bandwidth b_{sw2c} and the number N of subqueues Q times the edge bandwidth b_{sw2c} is less than the bandwidth between the server 10 and the edge server 20 b_{s2sw}. For example, the server 10 may determine that the flow of the packet lake PL packets is limited by the edge bandwidth b_{sw2c} if the inequality B≤N*b_{sw2c}<b_{s2sw} is true.

If the server determines that the flow of the packet lake PL packets is limited by the edge bandwidth b_{sw2c} and that the time interval δ since the last time that the server 10 increased the bitrate B has passed (Y at S1110), then the method proceeds to S1120.

At S1120, the server 10 increases the bitrate B to a temporary bitrate B′ for a duration of τ. For example, the duration τ may be set to 500 milliseconds. However, example embodiments are not limited to this example. For example, the server 10 may determine the bitrate B′ as being equal to a minimum of a bitrate between the server 10 and the edge server 20 b_{s2sw} and 1.5 times the bitrate B (e.g., min(b_{s2sw}, 1.5*B).

This transmit bitrate increase allows the server 10 to determine if the edge network has any headroom for additional bandwidth. Outside of this probing step, any changes in the edge server 20 to UE 30 link will be reflected in an updated b_{sw2c} and cause the server 10 to update the bitrate B.

For example, the server 10 may transmit the packet lake PL packets at the temporary bitrate B′ for the duration τ and may proceed to S1130 at the expiration of the duration τ and continue as described below.

Returning to S1110, if the server determines that the flow of the packet lake PL packets is not limited by the edge bandwidth b_{sw2c} and/or that the time interval δ has not passed since a last time that the server 10 increased the bitrate B (N at S1110), then the method proceeds to S1130.

At S1130, the server 10 updates values of the server 10 to edge server 20 bitrate b_{s2sw} and the edge server 20 to UE 30 bitrate b_{sw2c}. For example, the server 10 may update the bitrates b_{s2sw} and b_{sw2c} based on most recent ACK messages 71 and/or 72.

At S1140, the server 10 updates the bitrate B according to the bitrates b_{s2sw} and b_{sw2c}. For example, the server 10 may set the bitrate B equal to a minimum of the bitrate b_{s2sw} or the bitrate b_{sw2c}.

FIG. 12 is a flowchart illustrating another method according to example embodiments. The method shown in FIG. 12 may be performed at the server 10. For example, the method shown in FIG. 12 may be performed by the processor 12 of the server 10.

Referring to FIG. 12, at S1200, the server 10 segments volumetric video (e.g., a 3D scene of a volumetric video). For example, the server 10 may segment the volumetric video in response to a request from a UE 30 for the volumetric video. For example, the server 10 may segment the volumetric video into N separate subqueues Q as discussed with regard to FIGS. 4A-4C. For example, the server 10 may segment the volumetric video based on just field-of-view angles, or based on semantics of the scene, e.g., identifying specific object types (cars, buildings, etc.) that will fall into different segments. For example, areas of the volumetric video that have greater mobility (or changes) may be divided into different segments from more static areas of the scene.

At S1210, the server 10 determines a scene priority p for various objects/regions of the volumetric video (e.g., a 3D scene of the volumetric video). For example, the server may divide the volumetric video into a plurality of packets. The server 10 may determine a scene priority p for each packet of the plurality of packets. For example, a scene can be partitioned into dynamic vs. static regions, or foreground vs. background objects, with dynamic foreground objects assigned a higher scene priority p as they will be the focus of the user experience.

The server 10 may determine the scene priorities p of the plurality of packets based on an available bandwidth between the server 10 and the UE 30. The server 10 may determine the available bandwidth as discussed with regard to FIG. 11.

The server 10 may indicate the scene priority of a packet in the priority field of a header of the packet, as discussed with reference to FIG. 7.

At S1220, the server 10 partitions the plurality of packets into corresponding subqueues Q. For example, the server 10 may indicate the subqueue Q of a packet in the subqueue_id field of a header of the packet, as discussed with reference to FIG. 7.

At S1230, the server 10 generates a lake manifest describing the mapping between the spatial segments and the subqueues Q. The server 10 may periodically update the lake manifest. For example, the server 10 may update the lake manifest in response to receiving a client state (e.g., an updated client state) from the UE 30.

At S1240, the server 10 transmits the lake manifest to the UE 30. For example, the server 10 may transmit the lake manifest to the UE 30 via the edge server 20.

At S1250, the server 10 transmits the volumetric video (e.g., the plurality of packets) to the edge server 20. For example, the server 10 may transmit the plurality of packets to the edge server 20 for delivery to the UE 30.

FIG. 13 is a flowchart illustrating another method according to example embodiments. The method shown in FIG. 13 may be performed at the edge server 20. For example, the method shown in FIG. 13 may be performed by the processor 12 of the edge server 20.

Referring to FIG. 13, at S1300 the edge server 20 receives the plurality of packets from the server 10.

At S1310, the edge server 20 organizes and/or maintains the received plurality of packets in a packet lake PL. For example, the edge server 20 may place a packet of the plurality of packets at a head of a linked list L corresponding with a scene priority p of the packet, the linked list L belonging to a subqueue Q corresponding with a subqueue ID of the packet.

At S1320, the edge server 20 determines if the subqueue Q is full. For example, the edge server 20 may determine that the subqueue Q is full if the subqueue Q contains more than M packets. If the edge server 20 determines that the subqueue Q is full (Y at S1320), then the method proceeds to S1330.

At S1330, the edge server 20 drops a random packet, of a plurality of packets in the full subqueue Q. For example, the edge server 20 may determine the random packet based on a scene priority of the newly added packet and the circular sampling buffer 1000, as discussed with reference to FIG. 10. The method then proceeds to S1340.

Returning to S1320, if the edge server 20 determines that the subqueue Q is not full (N at 1320) then the method proceeds to S1340.

At S1340, the edge server 20 generates an ACK message 71 for each received packet and transmits the ACK message 71 to the server 10.

At S1350, the edge server 20 receives a request from the UE 30. For example, the request may be in the form of ACK message 72.

At S1360, the edge server 20 determines a priority P for each subqueue Q. For example, the edge server 20 may determine the subqueue priority P for each subqueue Q based on the request from the UE 30. For example, the ACK message 72 may include an array indicating a subqueue priority P of each of the subqueues Q.

At S1370, the edge server 20 transmits video packets to the UE 30 based on the priorities P and the scene priorities p. For example, the edge server 20 may dequeue a video packet from the subqueues Q to the output queue QO for transmitting to the UE 30 based on the priorities P and the scene priorities p. For example, the edge server 20 may dequeue the video packets from the subqueues Q according to a selected scheduling policy. For example, the selected scheduling policy may be one or a proportional scheduling policy or an ordered scheduling policy. However, example embodiments are not limited to this example.

FIG. 14 is a flowchart illustrating another method according to example embodiments. The method shown in FIG. 14 may be performed at the UE 30. For example, the method shown in FIG. 14 may be performed by the processor 12 of the UE 30.

Referring to FIG. 14, at S1400 the UE 30 transmits a request for a volumetric video. For example, the UE 30 may transmit the request to the server 10 via the edge server 20.

At S1410, the UE receives, from the edge server 20 video packet. The UE 30 may display a volumetric video to a user based on the received video packets.

At S1420, the UE 30 receives, from the server 10, the lake manifest describing the mapping between the spatial segments and the subqueues Q.

At S1430, the UE updates the subqueue priorities P. For example, the UE 30 may update the subqueue priorities P based on the lake manifest and based on a current FoV of the user with regard to the volumetric video.

At S1440, the UE 30 transmits an uplink client ACK 72 to notify the server 10 of a received packet and to update subqueue priorities P on a packet lake PL stored at the edge server 20.

At S1450, the UE 30 determines whether the volumetric video is completed. For example, the UE 30 may determine that the volumetric video is completed in response to the user exiting the volumetric video. For another example, the UE 30 may determine that the volumetric video is completed based on a run time of the volumetric video and/or a defined end state of the volumetric video. However, example embodiments are not limited to these examples.

If the UE 30 determines that the volumetric video is not completed (N at S1450), then the method returns to S1410 and continues as described. If the UE 30 determines that the volumetric video is completed (Y at S 1450), then the method proceeds to S1460.

At S1460, the UE 30 ends the method.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing network apparatuses, elements or entities including cloud-based data centers, computers, cloud-based servers, or the like. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUs), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network apparatus, network element or network device to perform the necessary tasks. Additionally, the processor, memory and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, network apparatuses, elements or entities including cloud-based data centers, computers, cloud-based servers, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUs, one or more microprocessors, one or more ASICs, or any other device or devices capable of responding to and executing instructions in a defined manner.

What is claimed is:

1. An apparatus comprising:
at least one memory storing computer program code; and
at least one processor configured to execute the computer program code and cause the apparatus to
receive a plurality of volumetric video packets of a volumetric video,
store the plurality of volumetric video packets in a two-dimensional packet buffer, the two-dimensional packet buffer including a plurality of priority sub-queues,
discard a stored volumetric data packet from a randomly selected priority sub-queue, of the plurality of priority sub-queues, in response to
receiving a further volumetric video packet, and
the two-dimensional packet buffer being full, and
transmit a volumetric video packet from the two-dimensional packet buffer to a client device.

2. The apparatus of claim 1, wherein each priority sub-queue of the plurality of priority sub-queues corresponds with a respective segment of the volumetric video.

3. The apparatus of claim 1, wherein the at least one memory and the computer program code are further configured to, with the at least one processor, cause the apparatus to transmit the volumetric video packet from the two-dimensional packet buffer to the client device based on a sub-queue priority received from the client device.

4. The apparatus of claim 3, wherein the sub-queue priority is based on a field of vision of a user.

5. The apparatus of claim 1, wherein the at least one memory and the computer program code are further configured to, with the at least one processor, cause the apparatus to discard the stored volumetric video packet based on a circular sampling buffer.

6. The apparatus of claim 5, wherein the at least one memory and the computer program code are further configured to, with the at least one processor, cause the apparatus to
store a received volumetric video packet in a priority sub-queue, of the plurality of priority sub-queues, corresponding with a sub-queue priority of the volumetric video packet, and
add an entry to the circular sampling buffer corresponding with the received volumetric video packet.

7. The apparatus of claim 6, wherein
the priority sub-queue is a priority linked list, and
the at least one memory and the computer program code are further configured to cause the apparatus to store the received volumetric video packet in the priority linked list according to a scene priority level of the volumetric video packet.

8. The apparatus of claim 1, wherein the at least one memory and the computer program code are further configured to, with the at least one processor, cause the device to, in response to receiving the further volumetric video packet and the two-dimensional packet buffer being full,
randomly select an entry from a circular sampling buffer,
discard a lowest priority volumetric video packet from a priority sub-queue of the plurality of priority sub-queues corresponding with a sub-queue priority of the selected entry, and
discard an entry from the circular sampling buffer corresponding with the discarded volumetric video packet.

9. A client device comprising:
at least one memory storing computer program code; and
at least one processor configured to execute the computer program code to cause the client device to
determine a sub-queue priority based on a field of view of a user,
transmit the sub-queue priority to an apparatus having a two-dimensional packet buffer including a plurality of priority sub-queues, each of the plurality of priority sub-queues including a plurality of volumetric video packets of a volumetric video,
receive, from the apparatus, volumetric video packets from one or more of the plurality of priority sub-queues based on the sub-queue priority, and
display a volumetric video based on the volumetric video packets.

10. The client device of claim 9, wherein the at least one memory and the computer program code are further configured to cause the client device to determine the sub-queue priority based on a mapping between spatial segments of the volumetric video and the plurality of priority sub-queues.

11. The client device of claim 9, wherein the at least one memory and the computer program code are further configured to cause the client device to
transmit a client state of the user to a server, and
receive, from the server, an updated mapping between spatial segments of the volumetric video and the plurality of priority sub-queues based on the client state.

12. A method for transmitting volumetric video, the method comprising:
receiving a plurality of volumetric video packets of the volumetric video;
storing the plurality of volumetric video packets in a two-dimensional packet buffer, the two dimensional packet buffer including a plurality of priority sub-queues;
discarding a stored volumetric data packet from a randomly selected priority sub-queue, of the plurality of priority sub-queues, in response to
receiving a further volumetric video packet, and
the two-dimensional packet buffer being full; and
transmitting a volumetric video packet from the two-dimensional packet buffer to a client device.

13. The method of claim 12, wherein each priority sub-queue of the plurality of priority sub-queues corresponds with a respective segment of the volumetric video.

14. The method of claim 12, further comprising:
transmitting the volumetric video packet from the two-dimensional packet buffer to the client device based on a sub-queue priority received from the client device.

15. The method of claim 14, wherein the sub-queue priority is based on a field of vision of a user.

16. The method of claim 12, further comprising:
discarding the stored volumetric video packet based on a circular sampling buffer.

17. The method of claim 16, further comprising:
storing a received volumetric video packet in a priority sub-queue, of the plurality of priority sub-queues, corresponding with a sub-queue priority of the volumetric video packet; and
adding an entry to the circular sampling buffer corresponding with the received volumetric video packet.

18. The method of claim 17, wherein the priority sub-queue is a priority linked list, and wherein the method further comprises:
storing the received volumetric video packet in the priority linked list according to a scene priority level of the volumetric video packet.

19. The method of claim 12, further comprising:
in response to receiving the further volumetric video packet and the two-dimensional packet buffer being full
randomly selecting an entry from a circular sampling buffer,
discarding a lowest priority volumetric video packet from a priority sub-queue of the plurality of priority sub-queues corresponding with a sub-queue priority of the selected entry, and
discarding an entry from the circular sampling buffer corresponding with the discarded volumetric video packet.

20. A non-transitory computer-readable storage medium storing computer-executable instructions that, when executed by at least one processor at an apparatus, cause the apparatus to perform the method of claim 12.
